(19) United States
(12) Patent Application Publication
(10) Pub. No.: US 2008/0162557 A1
(43) Pub. Date: Jul. 3, 2008

(54) SYSTEMS, METHODS, DEVICES, AND COMPUTER PROGRAM PRODUCTS PROVIDING FOR REFLECTIVE MEDIA

(75) Inventors: Peter Boda, Helsinki (FI); Balazs Bakos, Szent Laszlo (HU); Jukka K. Nurminen, Espoo (FI)

Correspondence Address: ALSTON & BIRD LLP, BANK OF AMERICA PLAZA, 101 SOUTH TRYON STREET, SUITE 4000, CHARLOTTE, NC, 28280-4000, US

(73) Assignee: Nokia Corporation

(21) Appl. No.: 11/617,167

(22) Filed: Dec. 28, 2006

(51) Int. Cl. G06F 17/30

(52) U.S. Cl. 707/104.1

(57) ABSTRACT

Systems, methods, devices, and computer program products provide for a reflective media system, where the source of a media file may automatically receive information about how recipients of the media file are using the media file. For example, a user may communicate copies of the user's media files to a community of other people, such as friends, family, schoolmates, co-workers, and the like. As the people in the community annotate or edit their copies of the media files, these annotations or edits are communicated back to the user, i.e., the source of the media files. The user can then use these annotations or edits in order to annotate or edit the user's copy of the media files in a similar way. A system may also be provided for reflecting more general use information back to the source of a shared media file.

### FIELD OF EMBODIMENTS OF THE INVENTION

Embodiments of the invention relate generally to handling of multimedia material, particularly in a mobile environment. More particularly, embodiments of the present invention relate to systems, methods, devices, and computer program products for providing information to a source of a media file about a recipient's use of the media file.

### BACKGROUND OF EMBODIMENTS OF THE INVENTION

Mobile terminals, such as mobile phones, portable digital assistants (PDAs), laptop computers, and the like, have become increasingly versatile and offer a wide variety of multimedia functions. As a result, it is easy for almost anyone to create and/or store massive amounts of multimedia data. With so much data being created, modified, shared, and stored, there is a need for systems and methods of organizing all this data in a useable way.

In particular, non text-based media files, such as digital picture files, audio files, and video files, often present the greatest organizational problems. For example, with text-based documents, even if the documents are not well organized, a user can use a text-based search application to quickly search the contents of a large group of document files in order locate a particular document file in the group. In contrast, image, audio, and video files cannot be easily searched using a text-based search application.

To organize both text and non text-based media files, many users assign descriptive file names to the media files. In addition to creating descriptive file names, many users will also create one or more folders and subfolders to appropriately categorize media files by grouping like media files together in a common folder or subfolder. Typically, a user will also assign descriptive names to the folders and subfolders that the user creates. Unfortunately, many users do not have the time to appropriately name and categorize all of the media files that they accumulate. For example, a typical digital camera user may easily accumulate hundreds if not thousands of digital pictures in the memory of a digital camera before the user finally decides to download the pictures from the digital camera to the user's computer or primary storage location. With so many pictures to annotate all at once, the user will often become overwhelmed and will not annotate or otherwise organize any of the pictures.

Other solutions have been developed that allow a user to annotate media files by adding metadata to the media files that allow for the media files to be searched or automatically organized. For example, U.S. patent application Ser. No. 10/715,093 to Metsatahti et al. entitled “Bookmarking and Annotating in a Media Diary Application” and assigned to Nokia Corporation describes bookmarking and annotation mechanisms that provide for text notes and other annotations to be associated with media files. Although such solutions create an improved system for annotating or otherwise organizing media files and may make the process quicker for the user, the user must still annotate and categorize each and every media file that user wants to organize. Therefore, despite the advantages of such systems, many users will still not have the time to appropriately annotate and categorize all of their media files.

Accordingly, a system is needed that will reduce the effort that is required of a user to annotate or otherwise organize media files stored in the user's storage devices. Preferably, the system would allow for automatic annotation and organization of a user's media files in a way that is related to the subject matter of the media files. It should be noted that, although embodiments of the present invention may help solve the problem described above, other embodiments of the present invention may help solve other problems not discussed above.

### BRIEF SUMMARY OF EMBODIMENTS OF THE INVENTION

In general, embodiments of the present invention relate to systems, methods, devices, and computer program products for providing information to a source of a media file about a recipient's use of the media file. In one exemplary embodiment of the present invention a system, method, device, and/or computer program product is provided for annotating media files. For example, embodiments of the present invention may involve a user communicating the copies of the user's media files to a community of other people, such as friends, family, schoolmates, co-workers, and the like. As the people in the community annotate their copies of the media files, this annotation information is communicated back to the user, i.e., the source of the media file. The user can then use this annotation information to annotate the user's copy of the media files.

Other embodiments of the present invention generally provide a system for modifying media files using a similar technique of reflecting modifications made by others back to the source of the media file. Still other embodiments of the present invention reflect more general use information back to the source of a shared media file, such as information related to how recipients of the shared media file are using their copy of the shared media file, including, in some embodiments, contextual information about use of the shared media file.

In one embodiment of the present invention, a method of supplementing data stored in a source device operated by a first party is provided. The method includes: communicating the data to at least one recipient device operated by a second party; receiving use information from the at least one recipient device, the use information relating to an action taken with respect to the data following communication to the at least one recipient device; and supplementing the data stored in the source device based on the use information from the at least one recipient device. Supplementing the data stored in the source device may include annotating (e.g., adding metadata to) and/or editing (e.g., adding data to, deleting data from, and/or modifying) the data.

The method may further include determining how the data stored in the source device is to be supplemented when use information is received from two or more recipient devices. The method may include communicating source use information parameters that at least partially define the use information to be provided by the recipient device. The method may include communicating source use information parameters that at least partially define how the use information should be provided by the recipient device.

The use information may include a label that was assigned to the data in the at least one recipient device. If so, then supplementing the data may include assigning the label to the data stored in the source device. The use information may include organizational information based on how the data was organized in the at least one recipient device. If so, then supplementing the data may include organizing the data stored in the source device based on the organizational information.

In another embodiment of the present invention, a computer program product is provided for supplementing (e.g., editing and/or annotating) data stored in a source device operated by a first party, the computer program product comprising at least one computer-readable storage medium having computer-readable program code portions stored therein. The computer-readable program code portions include a first executable portion for communicating the data to at least one recipient device operated by a second party; a second executable portion for receiving use information from the at least one recipient device, the use information relating to an action taken with respect to the data following communication to the at least one recipient device; and a third executable portion for supplementing the data stored in the source device based on the use information from the at least one recipient device.

If the use information includes a label that was assigned to the data in the at least one recipient device, then the third executable portion may include an executable portion for assigning the label to the data stored in the source device. If the use information includes organizational information based on how the data was organized in the at least one recipient device, then the third executable portion may include an executable portion for organizing the data stored in the source device based on the organizational information.

The computer program product may include an executable portion for determining how the data stored in the source device is to be supplemented when use information is received from two or more recipient devices. The computer program product may include an executable portion for providing source use information parameters to the recipient device, the source use information parameters providing instructions to the at least one recipient device for the communication of use information back to the source device.

In one embodiment of the present invention, a source device operated by a first party is provided. The source device may include a memory device for storing data, and a processor operatively coupled to the memory device. The processor may be configured to: communicate the data to at least one recipient device operated by a second party; receive use information from the at least one recipient device, the use information relating to an action taken with respect to the data following communication to the at least one recipient device; and supplement the data stored in the source device based on the use information from the at least one recipient device.

If the use information includes a label that was assigned to the data in the at least one recipient device, then the processor may be configured to assign the label to the data stored in the source device. If the use information includes organizational information based on how the data was organized in the at least one recipient device, then the processor may be configured to organize the data stored in the source device based on the organizational information.

The processor of the source device may be configured to determine how the data stored in the source device is to be supplemented when use information is received from two or more recipient devices. The processor of the source device may be configured to provide source use information parameters to the recipient device, the source use information parameters providing instructions to the at least one recipient device for the communication of use information back to the source device.

In one embodiment of the present invention, a method is provided including: receiving data at a recipient device, the data being received from a source device; taking action with respect to the data following receipt at the recipient device; and communicating use information to the source device, the use information relating to an action taken with respect to the data. The method may further include: receiving source use information parameters with the data and communicating use information based on the source use information parameters. The method may also include communicating use information based on recipient use information parameters, the recipient use information parameters being stored in the recipient device. The method may further include prioritizing between the recipient use information parameters and the source use information parameters.

The method may include transmitting the data to at least one other device; receiving other device use information from the at least one other device, the other device use information relating to an action taken by at least one other device with respect to the data after the transmission of the data to the at least one other device; and communicating the other device use information to the source device.

In one embodiment of the present invention, a computer program product is provided, having at least one computer-readable storage medium having computer-readable program code portions stored therein. The computer-readable program code portions include: a first executable potion for receiving data at a recipient device, the data being received from a source device; a second executable portion for taking action with respect to the data following receipt at the recipient device; and a third executable portion for communicating use information to the source device, the use information relating to an action taken with respect to the data.

The computer program product may further include an executable portion for receiving source use information parameters from the source device, wherein the third executable portion comprises an executable portion for communicating use information based on the source use information parameters. The computer program product may include an executable portion for providing recipient use information parameters, wherein the third executable portion comprises an executable portion for communicating use information based on the recipient use information parameters. The computer program product may include an executable portion for prioritizing between the recipient use information parameters and the source use information parameters.

The computer program product may include: an executable portion for transmitting the data to at least one other device; and an executable portion for receiving other device use information from the at least one other device, the other device use information relating to an action taken by at least one other device with respect to the data after the transmission of the data to the at least one other device. The third executable portion may include an executable portion for communicating the other device use information to the source device.

In one embodiment of the present invention, a recipient device is provided having a communication interface, and a processor operatively coupled to the communication interface. The processor may be configured to: receive data via the communication interface, the data being received from a source device; take action with respect to the data; and communicate use information to the source device via the communication interface, the use information relating to an action taken with respect to the data.

The processor of the recipient device may be configured to receive source use information parameters via the communication interface and communicate use information based on the source use information parameters. The recipient device may include a memory operatively coupled to the processor and having recipient use information parameters stored therein. If so, the processor may be configured to communicate use information based on recipient use information parameters. The processor may be configured to prioritize between the recipient use information parameters and the source use information parameters.

The processor of the recipient device may be configured to: transmit the data to at least one other device via the communication interface; receive other device use information from the at least one other device via the communication interface, the other device use information relating to an action taken by at least one other device with respect to the data after the transmission of the data to the at least one other device; and communicate the other device use information to the source device via the communication interface.

Embodiments of the present invention may also comprise a reflective media system. The reflective media system may include a recipient device configured to receive a media file and metadata associated with the media file and store the media file in a memory of the recipient device. The metadata may include source information related to the source of the media file. The recipient device may be configured to communicate use information to another device based on the source information, the use information comprising information about how the recipient device has used the media file stored in the memory of the recipient device.

The recipient device may be configured to communicate the use information automatically if the source information contains information about a source that is included on a list of approved sources stored in the memory of the recipient device. The source information may include an address of a source device, and the recipient device may be configured to communicate use information to the address of the source device.

The source information may include an address of an intermediary server connected to the Internet, and the recipient device may be configured to communicate use information to the intermediary server via the Internet. If so, the intermediary server may be configured to process the use information and provide information related to the use information to a source device, the source device having provided the media file to the recipient device. In one embodiment, the source device may have provided the media file to the recipient device via the intermediary server.

The use information in the reflective media system may include metadata that the recipient device added to the media file or may include edits that the recipient device made to the media file. The use information may include information about whether the recipient device printed, forwarded, modified, or viewed the media file stored in the memory of the recipient device. The use information may include information about at least one other media file stored in the memory of the recipient device that the recipient device associated with the media file.

### BRIEF DESCRIPTION OF THE SEVERAL VIEWS OF THE DRAWING(S)

Having thus described the invention in general terms, reference will now be made to the accompanying drawings, which are not necessarily drawn to scale, and wherein:

FIG. 1 is a schematic diagram of a network in which embodiments of the present invention may be configured to operate;

FIG. 2 is a schematic block diagram of a mobile terminal in accordance with one embodiment of the present invention;

FIG. 3 is a schematic block diagram of one type of system in which embodiments of the present invention may be configured to operate, according to one embodiment of the present invention;

FIG. 4 is a block diagram illustrating a reflective media system in accordance with one embodiment of the present invention;

FIG. 5 is a flow chart diagram illustrating a system architecture and a process for reporting, to the source of a media file, information about the use of the media file by a recipient device, in accordance with one embodiment of the present invention;

FIG. 6 is a flow chart diagram illustrating a system architecture and a process for reporting, to the source of a media file, modifications to the media file made by a recipient device, in accordance with another embodiment of the present invention;

FIG. 7 is a block diagram illustrating how use information may be communicated when a media file is forwarded by a first recipient device to a second recipient device in accordance with one embodiment of the present invention; and

FIG. 8 is a schematic diagram of a network in which some embodiments of the present invention may be configured to operate.

### DETAILED DESCRIPTION OF EMBODIMENTS OF THE INVENTION

The present invention now will be described more fully hereinafter with reference to the accompanying drawings, in which some, but not all embodiments of the inventions are shown. Indeed, these inventions may be embodied in many different forms and should not be construed as limited to the embodiments set forth herein; rather, these embodiments are provided so that this disclosure will satisfy applicable legal requirements. Like numbers refer to like elements throughout.

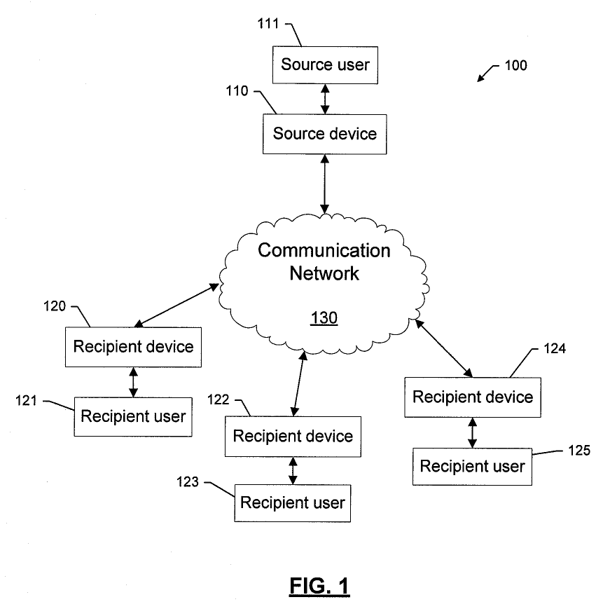

FIG. 1 is a schematic diagram of a network 100 in which embodiments of the present invention may be configured to operate. In particular, FIG. 1 illustrates a system in which a source user 111 uses a source device 110 to communicate with one or more recipient users via one or more recipient devices, such as the three illustrated recipient users 121, 123, and 125, and the three recipient devices 120, 122, and 124. Although FIG. 1 shows three recipient users each using a different recipient device, in some embodiments, more than one recipient user may share a recipient device. In one embodiment, the source user 111 and the recipient users 121, 123, and 125 are different people.

The source device 110 and the recipient devices 120-122 are configured to communicate via a communication network 130. The communication network 130 may be a global area network (GAN), such as the Internet, a wide area network (WAN), a local area network (LAN), or any other type of network. The communication network 130 may provide for wireline, wireless, or a combination of wireline and wireless communication between devices in the network. In one embodiment, the communication between the source device 110 and a recipient device 120 is direct in that information is communicated from a communication interface in one device to a communication interface in the other device using a single wireline or wireless communication link between the two devices. In another embodiment, the communication between the source device 110 and the recipient device 120 is indirect in that information is communicated from a communication interface in one device to a communication interface in the other device via communication through one or more other intermediary devices.

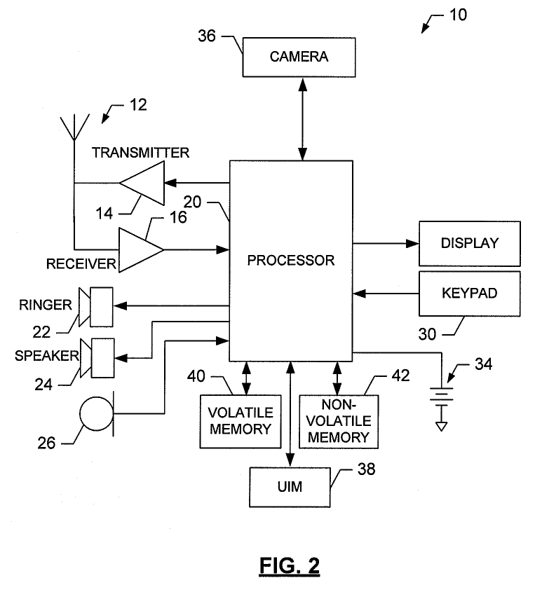

The source device 110 and the recipient device 120 may be any electronic device capable of manipulating and/or storing data. FIG. 2 illustrates a block diagram of an electronic device, and specifically a mobile terminal 10, that may be used as a source device 110 and/or a recipient device 120, in accordance with embodiments of the present invention. While several embodiments of the mobile terminal 10 are illustrated and will be hereinafter described for purposes of example, other types of electronic devices, such as digital cameras, portable digital assistants (PDAs), pagers, mobile televisions, computers, laptop computers, and other types of systems that manipulate and/or store data files, can readily employ embodiments of the present invention. Such devices may or may not be mobile.

The mobile terminal 10 includes a communication interface comprising an antenna 12 in operable communication with a transmitter 14 and a receiver 16. The mobile terminal 10 further includes a processor 20 or other processing element that provides signals to and receives signals from the transmitter 14 and receiver 16, respectively. The signals include signaling information in accordance with the air interface standard of the applicable cellular system, and also user speech and/or user generated data. In this regard, the mobile terminal 10 is capable of operating with one or more air interface standards, communication protocols, modulation types, and access types. By way of illustration, the mobile terminal 10 is capable of operating in accordance with any of a number of first, second and/or third-generation communication protocols or the like. For example, the mobile terminal 10 may be capable of operating in accordance with second-generation (2G) wireless communication protocols IS-136 (TDMA), GSM, and IS-95 (CDMA) or third-generation wireless communication protocol Wideband Code Division Multiple Access (WCDMA).

It is understood that the processor 20 includes circuitry required for implementing audio and logic functions of the mobile terminal 10. For example, the processor 20 may be comprised of a digital signal processor device, a microprocessor device, and various analog to digital converters, digital to analog converters, and other support circuits. Control and signal processing functions of the mobile terminal 10 are allocated between these devices according to their respective capabilities. The processor 20 thus may also include the functionality to convolutionally encode and interleave message and data prior to modulation and transmission. The processor 20 can additionally include an internal voice coder, and may include an internal data modem. Further, the processor 20 may include functionality to operate one or more software programs, which may be stored in memory. For example, the processor 20 may be capable of operating a connectivity program, such as a conventional Web browser. The connectivity program may then allow the mobile terminal 10 to transmit and receive Web content, such as location-based content, according to a Wireless Application Protocol (WAP), for example.

The mobile terminal 10 also comprises a user interface including an output device such as a conventional earphone or speaker 24, a ringer 22, a microphone 26, a display 28, and a user input interface, all of which are coupled to the processor 20. The user input interface, which allows the mobile terminal 10 to receive data, may include any of a number of devices allowing the mobile terminal 10 to receive data, such as a keypad 30, a touch display (not shown) or other input device. In embodiments including the keypad 30, the keypad 30 may include the conventional numeric (0-9) and related keys (#, *), and other keys used for operating the mobile terminal 10. Alternatively, the keypad 30 may include a conventional QWERTY keypad. The mobile terminal 10 further includes a battery 34, such as a vibrating battery pack, for powering various circuits that are required to operate the mobile terminal 10, as well as optionally providing mechanical vibration as a detectable output.

In an exemplary embodiment, the mobile terminal 10 includes a camera 36 in communication with the processor 20. The camera 36 may be any means for capturing an image for storage, display or transmission. For example, the camera 36 may include a digital camera capable of forming a digital image file from a captured image. As such, the camera 36 includes all hardware, such as a lens or other optical device, and software necessary for creating a digital image file from a captured image. Alternatively, the camera 36 may include only the hardware needed to view an image, while a memory device of the mobile terminal 10 stores instructions for execution by the processor 20 in the form of software necessary to create a digital image file from a captured image. In an exemplary embodiment, the camera 36 may further include a processing element such as a co-processor which assists the processor 20 in processing image data and an encoder and/or decoder for compressing and/or decompressing image data. The encoder and/or decoder may encode and/or decode according to a JPEG standard format.

The mobile terminal 10 may further include a user identity module (UIM) 38. The UIM 38 is typically a memory device having a processor built in. The UIM 38 may include, for example, a subscriber identity module (SIM), a universal integrated circuit card (UICC), a universal subscriber identity module (USIM), a removable user identity module (R-UIM), etc. The UIM 38 typically stores information elements related to a mobile subscriber. In addition to the UIM 38, the mobile terminal 10 may be equipped with memory. For example, the mobile terminal 10 may include volatile memory 40, such as volatile Random Access Memory (RAM) including a cache area for the temporary storage of data. The mobile terminal 10 may also include other non-volatile memory 42, which can be embedded and/or may be removable. The non-volatile memory 42 can additionally or alternatively comprise an EEPROM, flash memory or the like, such as that available from the SanDisk Corporation of Sunnyvale, Calif., or Lexar Media Inc. of Fremont, Calif. The memories can store any of a number of pieces of information, and data, used by the mobile terminal 10 to implement the functions of the mobile terminal 10. For example, the memories can include an identifier, such as an international mobile equipment identification (IMEI) code, capable of uniquely identifying the mobile terminal 10.

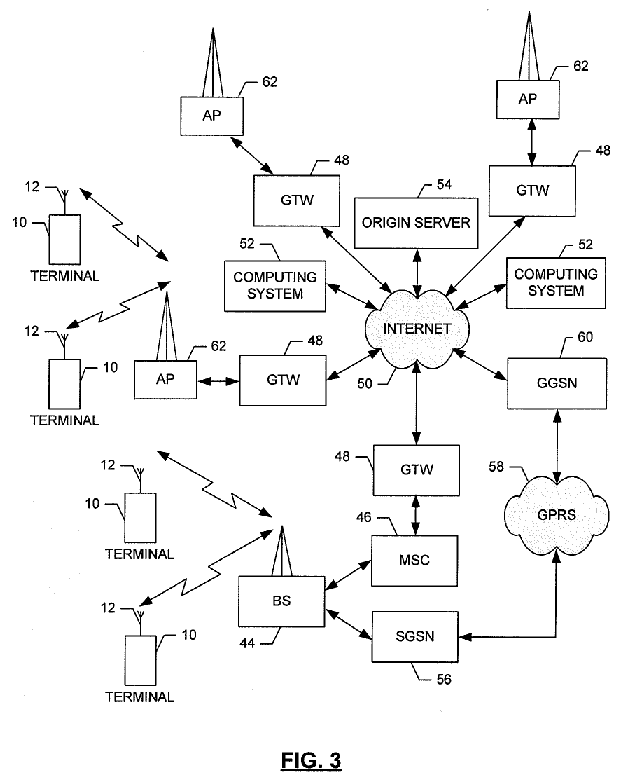

Referring now to FIG. 3, an illustration is provided of one type of system in which embodiments of the present invention may be configured to operate. The system includes a plurality of network devices. As shown, one or more mobile terminals 10 may each include an antenna 12 for transmitting signals to and for receiving signals from a base site or base station (BS) 44. The base station 44 may be a part of one or more cellular or mobile networks each of which includes elements required to operate the network, such as a mobile switching center (MSC) 46. As well known to those skilled in the art, the mobile network may also be referred to as a Base Station/MSC/Interworking function (BMI). In operation, the MSC 46 is capable of routing calls to and from the mobile terminal 10 when the mobile terminal 10 is making and receiving calls. The MSC 46 can also provide a connection to landline trunks when the mobile terminal 10 is involved in a call. In addition, the MSC 46 can be capable of controlling the forwarding of messages to and from the mobile terminal 10, and can also control the forwarding of messages for the mobile terminal 10 to and from a messaging center. It should be noted that although the MSC 46 is shown in the system of FIG. 3, the MSC 46 is merely an exemplary network device and embodiments of the present invention are not limited to use in a network employing an MSC.

The MSC 46 can be coupled to a data network, such as a local area network (LAN), a metropolitan area network (MAN), and/or a wide area network (WAN). The MSC 46 can be directly coupled to the data network. In one typical embodiment, however, the MSC 46 is coupled to a GTW 48, and the GTW 48 is coupled to a WAN, such as the Internet 50. In turn, devices such as processing elements (e.g., personal computers, server computers or the like) can be coupled to the mobile terminal 10 via the Internet 50. For example, as explained below, the processing elements can include one or more processing elements associated with a computing system 52 (two shown in FIG. 3), origin server 54 (one shown in FIG. 3) or the like, as described below.

The BS 44 can also be coupled to a signaling GPRS (General Packet Radio Service) support node (SGSN) 56. As known to those skilled in the art, the SGSN 56 is typically capable of performing functions similar to the MSC 46 for packet switched services. The SGSN 56, like the MSC 46, can be coupled to a data network, such as the Internet 50. The SGSN 56 can be directly coupled to the data network. In a more typical embodiment, however, the SGSN 56 is coupled to a packet-switched core network, such as a GPRS core network 58. The packet-switched core network is then coupled to another GTW 48, such as a GTW GPRS support node (GGSN) 60, and the GGSN 60 is coupled to the Internet 50. In addition to the GGSN 60, the packet-switched core network can also be coupled to a GTW 48. Also, the GGSN 60 can be coupled to a messaging center. In this regard, the GGSN 60 and the SGSN 56, like the MSC 46, may be capable of controlling the forwarding of messages, such as MMS messages. The GGSN 60 and SGSN 56 may also be capable of controlling the forwarding of messages for the mobile terminal 10 to and from the messaging center.

In addition, by coupling the SGSN 56 to the GPRS core network 58 and the GGSN 60, devices such as a computing system 52 and/or origin server 54 may be coupled to the mobile terminal 10 via the Internet 50, SGSN 56 and GGSN 60. In this regard, devices such as the computing system 52 and/or origin server 54 may communicate with the mobile terminal 10 across the SGSN 56, GPRS core network 58 and the GGSN 60. By directly or indirectly connecting mobile terminals 10 and the other devices (e.g., computing system 52, origin server 54, etc.) to the Internet 50, the mobile terminals 10 may communicate with the other devices and with one another, such as according to the Hypertext Transfer Protocol (HTTP), to thereby carry out various functions of the mobile terminals 10.

Although not every element of every possible mobile network is shown and described herein, it should be appreciated that the mobile terminal 10 may be coupled to one or more of any of a number of different networks through the BS 44. In this regard, the network(s) can be capable of supporting communication in accordance with any one or more of a number of first-generation (1G), second-generation (2G), 2.5G, third-generation (3G) and/or future mobile communication protocols or the like. For example, one or more of the network(s) can be capable of supporting communication in accordance with 2G wireless communication protocols IS-136 (TDMA), GSM, and IS-95 (CDMA). Also, for example, one or more of the network(s) can be capable of supporting communication in accordance with 2.5G wireless communication protocols GPRS, Enhanced Data GSM Environment (EDGE), or the like. Further, for example, one or more of the network(s) can be capable of supporting communication in accordance with 3G wireless communication protocols such as Universal Mobile Telephone System (UMTS) network employing Wideband Code Division Multiple Access (WCDMA) radio access technology. Some narrow-band AMPS (NAMPS), as well as TACS, network(s) may also benefit from embodiments of the present invention, as should dual or higher mode mobile stations (e.g., digital/analog or TDMA/CDMA/analog phones).

The mobile terminal 10 can further be coupled to one or more wireless access points (APs) 62. The APs 62 may comprise access points configured to communicate with the mobile terminal 10 in accordance with techniques such as, for example, radio frequency (RF), Bluetooth (BT), infrared (IrDA) or any of a number of different wireless networking techniques, including wireless LAN (WLAN) techniques such as IEEE 802.11 (e.g., 802.11a, 802.11b, 802.11g, 802.11n, etc.), WiMAX techniques such as IEEE 802.16, and/or ultra wideband (UWB) techniques such as IEEE 802.15 or the like. The APs 62 may be coupled to the Internet 50. Like with the MSC 46, the APs 62 can be directly coupled to the Internet 50. In one embodiment, however, the APs 62 are indirectly coupled to the Internet 50 via a GTW 48. Furthermore, in one embodiment, the BS 44 may be considered as another AP 62. As will be appreciated, by directly or indirectly connecting the mobile terminals 10 and the computing system 52, the origin server 54, and/or any of a number of other devices, to the Internet 50, the mobile terminals 10 can communicate with one another, the computing system, etc., to thereby carry out various functions of the mobile terminals 10, such as to transmit data, content or the like to, and/or receive content, data or the like from, the computing system 52. As used herein, the terms “data,” “content,” “information” and similar terms may be used interchangeably to refer to data capable of being transmitted, received and/or stored in accordance with embodiments of the present invention. Thus, use of any such terms should not be taken to limit the spirit and scope of the present invention.

Although not shown in FIG. 3, in addition to or in lieu of coupling the mobile terminal 10 to computing systems 52 across the Internet 50, the mobile terminal 10 and computing system 52 may be coupled to one another and communicate in accordance with, for example, RF, BT, IrDA or any of a number of different wireline or wireless communication techniques, including LAN, WLAN, WiMAX and/or UWB techniques. One or more of the computing systems 52 can additionally, or alternatively, include a removable memory capable of storing content, which can thereafter be transferred to the mobile terminal 10. Further, the mobile terminal 10 can be coupled to one or more electronic devices, such as printers, digital projectors and/or other multimedia capturing, producing and/or storing devices (e.g., other terminals). Like with the computing systems 52, the mobile terminal 10 may be configured to communicate with the portable electronic devices in accordance with techniques such as, for example, RF, BT, IrDA or any of a number of different wireline or wireless communication techniques, including USB, LAN, WLAN, WiMAX and/or UWB techniques.

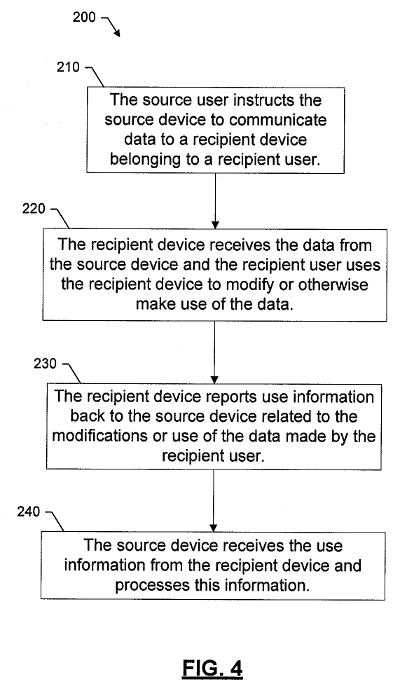

Referring now to FIG. 4, a block diagram is depicted illustrating the operation of a reflective media system 200 in accordance with one embodiment of the present invention. As represented by block 210, the source user 111 instructs the source device 110 to communicate data to a recipient user 121 by communicating the data to a recipient device 120. The data may comprise any type of data such as multimedia data. In one embodiment, the data comprises one or more media files, such as digital picture files, document files, audio files, video files, slide show presentation files, spreadsheet files, and the like. In some embodiments, metadata associated with the data is communicated to the recipient device with the data. As represented by block 220, the recipient device 120 receives data from the source device 110 and the recipient user 121 uses the recipient device 120 to modify or otherwise make use of the data. As illustrated by block 230, the recipient device then sends use information back to the source device 110, the use information related to the modifications that the recipient device made to the data or to how the recipient device otherwise used the data. The source device then receives the use information from the recipient device and processes this information, as represented by block 240. In one embodiment, the use information is communicated from the recipient device to the source device automatically, requiring little or no user input other than perhaps approval of the transmission by the recipient user.

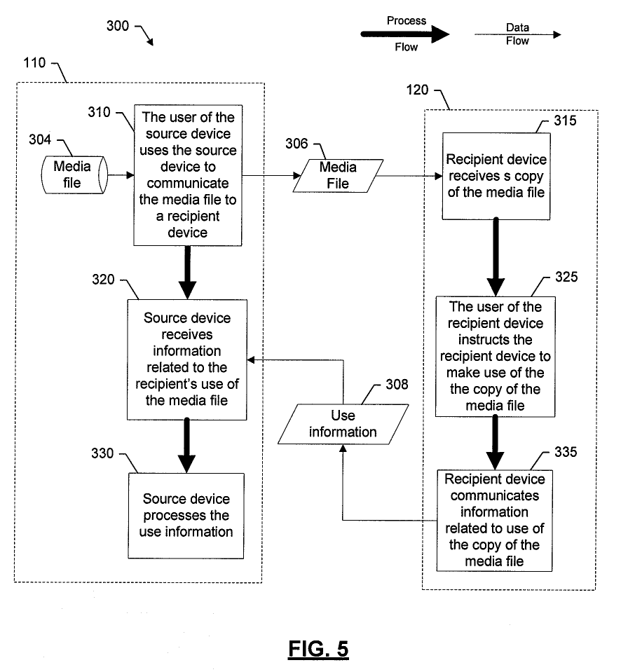

FIG. 5 illustrates a more detailed depiction of a reflective media system 300 in accordance with one embodiment of the present invention. FIG. 5 illustrates the data flow between a source device 110 and a recipient device 120, in accordance with one embodiment of the present invention. FIG. 5 also illustrates the process flow in each of the devices 110 and 120 in accordance with one embodiment of the present invention.

In the illustrated embodiment, the source device 110 has a media file 304 stored in a memory of the source device 110. Although FIG. 5 and the following description refer to a media file 304, any other type of data may be communicated in accordance with other embodiments of the present invention. As described above, the media file 304 may be any type of media file, such as a digital picture file, a music file or other audio file, a video file, a document or other text file, etc. The source user 111 may have used the source device 110 to create the media file 304. Alternatively, the source user 111 may have used some other device to create the media file 304 and then communicated the media file 304 to the source device 110 and stored the media file 304 in a memory of the source device 110. Of course, the source user 111 may not have created the media file 304 at all and may have only received the media file 304 from some other person or device. In this regard, the word “source” is used herein to distinguish between the user/device that sends a media file 304 and the user/device that receives the media file 304. The word “source” is not intended to indicate that the user/device necessarily created the media file 304 or was even the first user/device to have ever communicated the media file to another. Furthermore, a source device in one transaction may be a recipient device in another transaction. For example, a device may receive a media file and, therefore, may be considered a recipient device 120 for purposes that transaction. The same device may then be used to forward the same media file, or some modification thereof, to someone else, in which case the device may be considered a source device 110 for purposes of that transaction.

As represented by block 310, the source user 111 instructs the source device 110 to communicate a copy of the media file 306 to a recipient user 121 who is connected to the communication network 130 using a recipient device 120. The copy of the media file 306 communicated to the recipient device 120 is generally identical to the media file 304 stored in the source device 110, however, in some embodiments, the media file 306 communicated to the recipient device 120 may be different in some respects from the media file 304 stored in the source device 110. For example the media file 306 sent to the recipient device 120 may or may not include the same metadata as any metadata embedded in or otherwise associated with the media file 304 stored in the source device 110.

As represented by block 315, the recipient user 121 receives the copy of the media file 306 at recipient device 120. In one embodiment, the copy of the media file 306 is automatically stored in the recipient device 120 upon the recipient device's receipt of the media file 306. The recipient user 121 then instructs the recipient device 120 to make use of the copy of the media file 306, as represented by block 325. The recipient user 121 may communicate instructions to the recipient device 120 using any technique known in the art, such as by actuating a user input device on the recipient device 120. The recipient user 121 may provide instructions to the recipient device 120 at any time. For example, the recipient user 121 may provide instructions after the recipient device 120 receives the media file 306 or the recipient user 121 may provide instructions to the recipient device 120 before the media file 306 arrives at the recipient device 120. For example, in one embodiment, the system is configured to allow the recipient user 121 to instruct the recipient device 120 to always perform in a certain way in response to receiving media files from a particular source user 111.

The recipient device 120 may make use of the copy of the media file 306 by performing various actions involving the copy the media file 306. For example, in response to instructions received from a recipient user 121, the recipient device 120 may display, save, delete, copy, forward, print, edit, or annotate the copy of the media file 306. For example, the recipient user 121 may use the recipient device 120 to add metadata to or otherwise associate metadata or other forms of annotations with the copy of the media file 306. The recipient user 121 may use an application on the recipient device 120 to perform post-processing tasks on the copy of the media file 306, such as performing red-eye reduction to a digital picture. The recipient user 121 may create one or more folders and/or subfolders and place a copy of the media file 306 into these folders or subfolders. The recipient user 121 may create descriptive names or other labels for the copy of the media file and/or any folders or subfolders in which the media file is placed. The recipient user 121 may save a copy of the media file 306 in an already existing folder or subfolder that may contain other media files or the recipient user 121 may otherwise associate the copy of the media file 306 with other media files or other data using other means. For example, if the media file comprises a music file, the recipient user 121 may add the media file 306 to a play list. In other words, the recipient user 121 may perform many different actions with the media file 306, and the above list of ways in which the recipient user 121 may use the recipient device 120 to perform some action involving the copy of the media file 306 is not intended to be exhaustive.

As represented by blocks 335 and 320, the use information 308 is then communicated from the recipient device 120 back to the source device 110. The use information 308 may comprise any type of information related to the recipient user's use of the copy of the media file 306. In this regard, the use information may comprise an indication of the type(s) of actions that the recipient user 121 performed on or with the media file. For example, the use information 308 may comprise an indication that the recipient user 121 displayed, saved, deleted, copied, forwarded, printed, annotated, and/or modified the copy of the media file 306. The use information 308 may further comprise other information related to these actions such as information, such as contextual information, related to how, where, and when these actions were taken, if such information is available.

If the recipient user 121 had forwarded one or more copies of the media file 306 to other people or devices, the use information 308 may include information related to who the media file 306 was forwarded or how the media file 306 was forwarded. If metadata or other annotations were added to the media file 306 by the recipient user, the added metadata or other annotations may be communicated in the use information 308. Such metadata may be communicated by itself or may be embedded in a modified copy of the media file and then communicated with the media file. Similarly, if modifications are made to the media file 306, the use information 308 may comprise the modifications or may comprise a copy of the modified media file.

If the recipient user 121 had placed a copy of the media file into one or more folders or subfolders in the recipient device 120, the use information 308 may comprise the name and/or the structure of the folder and/or subfolders that the media file was placed into. In one embodiment, the use information 308 may comprise information about other media files in the recipient device 120 that the recipient user 121 associated with the media file 306. For example, if the recipient user 121 placed a copy of the media file 306 into an existing folder with other media files, the use information 308 may comprise information about these other media files, such as the names of the files or even the files themselves. If the recipient user 121 had printed a copy of the media file 306, the use information may comprise the print settings that the recipient user 121 had used.

If the recipient user 121 displayed the media file on the display of the recipient device 120 or on another display coupled to the recipient device 120, the use information may comprise information about whether anyone was nearby or even information about who was nearby when the media file was displayed. Such information may be available if the recipient device 120, such as a mobile terminal, is configured to wirelessly communicate with other nearby mobile terminals, e.g., using a Bluetooth connection, and receive information from the nearby terminals about the users of these terminals. In sum, the use information may comprise any information related to the use of a media file that a source device communicated to a recipient device, in accordance with various embodiments of the present invention.

In one embodiment of the present invention, the use information 308 is communicated from the recipient device 120 to the source device 110 automatically, i.e., without requiring user input. In one exemplary embodiment, the use information 308 is communicated automatically by repeatedly sending new use information 308 to the source device 110, such as on a periodic basis or as additional use information becomes available. In another embodiment, the use information 308 is communicated automatically upon the recipient device 120 commencing or completing an action involving the media file 306. In another embodiment, the use information 308 is communicated automatically after the recipient user 111 signals to the recipient device 120 that the recipient device 120 is permitted to allow communication of use information 308 to the source device 110.

In some embodiments, the source user 111 specifies when to communicate use information 308 to the source device 110 and what to include in the communicated use information 308. In other embodiments, the recipient user 121 specifies such communication information. In still other embodiments, both the source user 111 and the recipient user 121 specify the communication information, with one user having priority over the other.

Once the source device 110 receives the use information 308, the source device 110 is configured to process this information, as represented by block 330. The source device 110 may process the use information 308 in a number of different ways in accordance with various embodiments of the present invention. For example, the source device 110 may store the use information 308 so that the source user 111 can view the use information 308 at the source user's convenience. The source device 110 may also be configured to automatically prompt the source user 111 using a user interface whenever use information 308 is received at the source device 110. When prompted with this information, the source user 111 may be provided with the options of viewing, saving, deleting, or incorporating the use information 308. Incorporating the use information may comprise, for example, associating the use information 308 with the media file 304 stored in the source device 110 or otherwise supplementing the media file 304 based on the use information 308. In this regard, incorporating the use information 308 may comprise modifying the media file 304 stored in the source device 110 based on the use information 308. Exactly how the use information 308 may be associated with the media file 304 or used to modify the media file 304 will often depend on the media file and the type of use information.

For example, if the use information 308 comprises metadata that the recipient user 121 associated with the media file 306, the source device 110 may also associate the metadata with the media file 304 stored in the source device 110. Such metadata may be embedded into the media file 304 or stored in a separate file associated with the media file 304. In one embodiment, where the metadata comprises a file name that the recipient user 121 used to name the file 306 stored in the recipient device 120, the source device 110 is configured to assign the same file name to the media file 304 stored in the source device 110. Where the metadata comprises information about the name and/or structure of a folder and/or subfolder in which the recipient user 121 placed the file, the source device 110 may be configured to create a folder and/or subfolder having the same name and/or structure and place the media file 304, or a copy of the media file, into the folder or subfolder. If the use information comprises a modified version of the media file 304, the source device may be configured to replace the media file 304 with the modified media file, or the source device may be configured to simply save a copy of the modified media file.

In some embodiments, the source device 110 may be configured to automatically incorporate certain use information in a particular way, without the source user 111 having to approve of each instance of incorporation. In such embodiments, if the incorporation of the use information 308 involves modifying the media file 304 or some other data in the source device 110, the source device 110 may be configured to automatically save a backup of the media file 304 or other data before the incorporation. In this way, changes made by incorporating the use information 308 can be undone by the source device 110 if the source user 111 chooses to do so. In some embodiments, where the source device 110 is configured to automatically incorporate use information 308 and where the source device 110 receives competing use information from different recipient devices, the source device 110 may use an algorithm, predefined prioritization scheme, or the like to determine what use information to incorporate.

Therefore, it should be appreciated that embodiments of the present invention can allow the source of a media file to see what others are doing with the media file. In some embodiments, if any changes are made to the media file by a recipient user, the changes or the modified media file may be reflected back to the source user. Similarly, if a recipient user adds metadata to a media file or otherwise annotates a media file, the added metadata or other annotations may be reflected back to the source user. The source user can then take this information that is reflected back from the recipient device and use it based on assumptions about the recipient user. Because the source user 111 will generally send copies of the media file to recipient users who share a common interest in the content of the shared media file 304, the use information 308 that is reflected back to the source device 110 will often be useful to the source user 111 for the same reasons that it was useful to the recipient user 121. For example, if the source user 111 is sharing a group of digital pictures and video files from a birthday party that the source user 111 attended, the recipient users would likely comprise other people that were also in attendance at the party. Thus, if a recipient user 121 files all of the digital pictures and video files into a folder entitled “Johnny's Birthday Party” and this fact is reflected back to the source device 110, then it is likely that the source user 111 may want the same files to be placed in a folder of the same name if the user has not already placed these files in an appropriate folder.

In another example, the recipient user 121 conducts some post-processing of the digital picture files that the recipient user 121 received from a source user 111, such as removing red-eye from all of the digital pictures. If copies of the recipient user's modified digital pictures are automatically reflected back to the source device 110, then time and effort can be saved since the source user 111 would not have to spend the time and effort removing the red-eye from his pictures. Furthermore, the source user 111 may not even possess the requisite software or know-how that would have allowed the source user 111 to remove the red-eye from the pictures himself.

In still another example, a slideshow presentation file is communicated from a source device 110 to a recipient device 120. The recipient user 121 then modifies the slideshow presentation file stored in the recipient device 120 by editing errors in the slideshow or by adding or removing content and/or slides in the slideshow. Embodiments of the present invention may automatically communicate such edits and/or additions to the source user 111 or may at least provide the recipient user 121 with the option of having the system communicate the use information back to the source device 111.

Therefore, it should be appreciated that embodiments of the present invention can be useful to prevent the source user 111 from duplicating editing and/or annotation efforts performed by recipient users 121 with respect to a media file that the source user 111 shared with a recipient user 121. Other embodiments may also communicate other data or files to the source user 111 that the recipient user 121 associates with the communicated data, or may communicate the names and addresses of people to whom the recipient user 121 forwarded copies of the media file. Obviously, the more recipient users that the source user sends media file copies to and the more recipient users that choose to or can be made to participate in a system of embodiments of the present invention, the more likely it is that the source user will receive useful information related to the media file.

Some embodiments may communicate more general use information related not just to how a media file was used by a recipient, but also the context in which the media file was used by the recipient. In this regard, the system may be configured to communicate information back to the user about where the user was located when the user used the media file and/or who else was near the user when the user used the media file. Such contextual use information may, in some embodiments, be automatically gathered by the recipient device. For example, the recipient device may have a GPS unit that can communicate where the user was when the user used a media file, or the recipient device may have a wireless transceiver that gathers identification information from nearby mobile terminals about the identity of the users of the nearby terminals. For example, in one embodiment, presentation material is communicated from a source device 110 to a recipient device 120. The recipient user 121 then presents the presentation material stored in the recipient device 120 at a conference. Embodiments of the present invention may automatically communicate, from the recipient device to the source device, such contextual information as: the conference at which the recipient user 121 presented the material; the location of the conference; people in the audience that viewed the presentation; how the presentation was received by the audience; what feedback the recipient user 121 received, and the like.

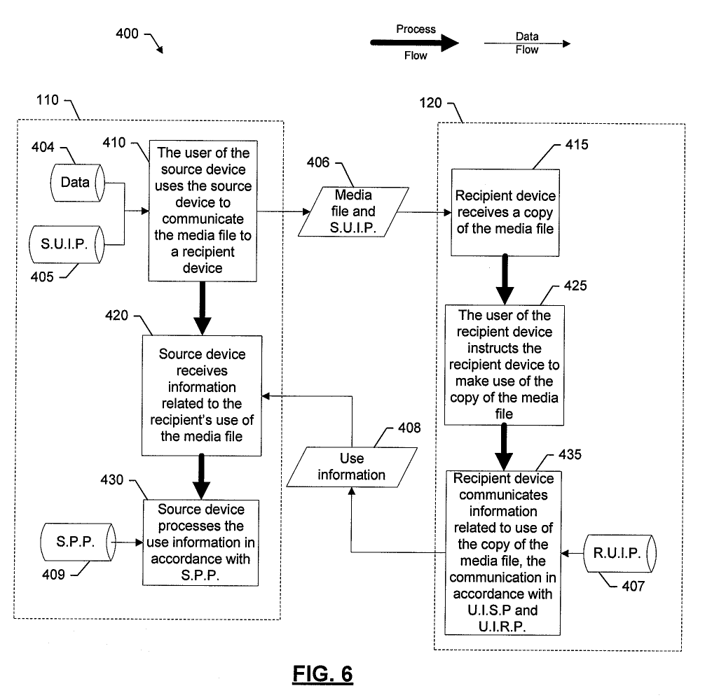

FIG. 6 illustrates a reflective media system 400 in accordance with another embodiment of the present invention. FIG. 6 is similar to FIG. 5 and illustrates the data flow between a source device 110 and a recipient device 120, in accordance with one embodiment of the present invention. FIG. 6 also illustrates the process flow in each of the devices 110 and 120 in accordance with one embodiment of the present invention.

In the system illustrated by FIG. 6, however, the source device 110 may include source use information parameters (S.U.I.P.) 405. These parameters 405 may be communicated to the recipient device 120 with the copy of the media file 406. The source use information parameters 405 contain information about how the source device 110 would like use information 408 to be communicated from the recipient device 120 to the source device 110. For example, the source use information parameters 405 may include information related to: (1) the types of use information that the source device would like to receive; (2) the times, situations, and/or frequency with which use information should be communicated to the source device; (3) the communication network, protocol, and/or address to be used for communicating with the source device; (4) the requested format of use information to be communicated to the source device; and the like. Such source use information parameters 405 may be hardcoded into the system, such as hardcoded into an application executed by the source device 110. Source use information parameters 405 may also be defined by the source user 111.

As represented by block 435, the recipient device may be configured to be able to read and understand the source use information parameters 405 and may be configured to communicate use information 408 back to the source device 110 in accordance with these instructions. However, in one embodiment of the invention, the recipient device 120 includes, e.g., has stored, recipient use information parameters (R.U.I.P.) 407 and the recipient device 120 communicates use information based on these parameters 407. These recipient use information parameters 407 may include information related to: (1) the types of use information that the recipient device is permitted to report back to the source device; (2) the times, situations, and/or frequency with which use information should be communicated to a source device; (3) the communication network, protocol, and/or address to be used for communicating with the source device; (4) the format of use information to be communicated to a source device; (5) a list of trusted source devices and/or source users that the recipient device is permitted to automatically communicate use information to (i.e., without any other approval from the recipient user); and the like. The recipient device 120 may have a single set of recipient use information parameters 407 that applies to all communication of use information 408 to source devices or the recipient use information parameters 407 may depend on a particular source device that is requesting use information. Recipient use information parameters 407 may be hardcoded into the system, such as hardcoded into an application executed by the recipient device 120. Recipient code information parameters 407 may also be defined by the recipient user 121.

Where both source and recipient use information parameters exist, one set of parameters may be given priority over the other. In one embodiment, in order for the recipient user 121 to view, save, or receive a copy of one of the source user's media files, the recipient user 121 is required to agree to communicate use information 408 back to the source device 110 and/or agree to communicate use information 408 in accordance with the source use information parameters 405.

Once the use information 408 is communicated to the source device 110, the source device 110 processes the use information 408. In the illustrated embodiment, the source device 110 has source processing parameters (S.P.P.) 409 and the source device 110 processes use information 408 in accordance with these parameters 409. For example, the source processing parameters 409 may include information related to the specific actions that the source device 110 should take when use information 408 is received. For example, the parameters may instruct the source device 110 to automatically display options for the source user 111 to choose from, such as options to view, save, delete, or incorporate the use information 408. Alternatively, the parameters 409 may instruct the source device 110 to automatically perform an action, such as the actions of displaying, saving, deleting, or incorporating the use information 408. The parameters 409 may be dependent upon the type of use information 408 and/or the particular recipient device 120 or recipient user 121. Source processing parameters 409 may be hardcoded into the system, such as hardcoded into an application executed by the source device 110, or may be defined by the source user 111.

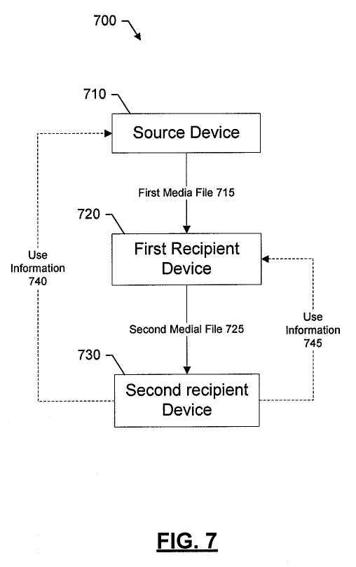

In some embodiments of the present invention, a recipient user may use a recipient device to forward a media file to another user and/or device. For example, FIG. 7 illustrates a system 700 in which a source device 710 communicates a media file 715 to a first recipient device 720. The first recipient device 720 (now acting as a source device) then chooses to send a media file 725, which may be identical to the media file 715 or may be a modified version of the media file 715, to a second recipient device 730. In such a case, if the second recipient device 730 uses the media file 725, use information 740 and 745 may be communicated back to the source device 710 and the first recipient device 720, respectively. The use information 740 communicated to the source device 710 may or may not be the same as the use information 745 communicated to the first recipient device 720. It may be possible for the second recipient device 730 to communicate use information 740 to the source device 710 if the metadata associated with the media file 725, such as source use information parameters, specified an address or communication method for communicating with the source device 710. In another embodiment, only use information 740 or only use information 745 is communicated from the recipient device. In an embodiment (not shown), where only use information 745 is communicated to the first recipient device 720, the source device 710 may receive information related to the second recipient device's use information 745 through use information communicated to the source device 710 from the first recipient device 720.

As described above, embodiments of the present invention involve communicating use information from a recipient device 120 to a source device 110. Such use information may be communicated in different ways according to different embodiments of the present invention. For example, in one embodiment of the present invention, the use information is communicated back to the source device 110 using the system described above with respect to FIG. 3. In one embodiment, use information is contained in an email to the source user. In another embodiment, use information is communicated back to the source device 110 in the form of a text messaging, SMS transfer, or other smart messaging service. In some embodiments, use information is communicated using a direct wireline or wireless connection between the recipient device and the user device, such as a USB cable or a Bluetooth connection. Other communication systems that may be used in embodiments of the present invention will be obvious to a person having ordinary skill in the art in light of this disclosure.

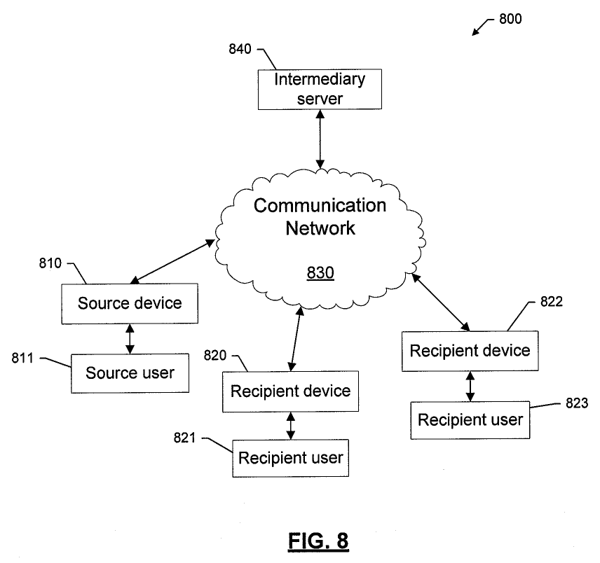

In one embodiment of the present invention, the use information is communicated back to the source device via an intermediary server connected to the communication network. For example, FIG. 8 is a schematic diagram of a network 800 in which embodiments of the present invention may be configured to operate in. In particular, FIG. 8 illustrates a system in which a source user 811 using a source device 810 communicates with one or more recipient users via one or more recipient devices, such as the two illustrated recipient users 821 and 823, and the two recipient devices 820 and 822. In the depicted embodiment, at least some information is communicated between the source device 810 and the one or more recipient devices 820 and 822 via an intermediary server 840. The source device 810 and the one or more recipient devices 820 and 824 communicate with the intermediary server 840 via the communication network 830, such as the Internet.

In this regard, in one embodiment of the present invention, use information is communicated from a recipient device 820 to the intermediary server 840. The source user 811 may then access the use information by using the source device 810 to communicate with and obtain use information from the intermediary server 840. For example, the intermediary server 840 may host one or more web pages that accumulate use information related to how recipients 120 and 122 are using media files provided by the source user 811 or the source device 810. The source device and/or other devices may access such web pages using a web browser application or some other application executed by the source device or other device. The web pages may be associated with a particular user or with a particular media file or group of media files and, in some embodiments, access to information on the server requires a login ID and/or a login password.

For example, in one embodiment of the present invention, a source user 811 uploads a media file and associated metadata from a source device 810 to an intermediary server 840. A recipient device 820 is then provided a URL and, if necessary login information, so that the recipient device can access the intermediary server 840 and download the media file and associated metadata to the recipient device 820. The recipient user 821 then modifies or otherwise makes use of the copy of the media file and/or associated metadata stored on the recipient device 820. The recipient device 820 may then automatically, or with user input, communicate use information, such as the modified media file and associated metadata, back to the intermediary server 840. The intermediary server 840 may then update its copy of the media file and associated metadata based on the use information received from the recipient device 820. For example, the intermediary server 840 may replace the media file and metadata currently displayed on the associated webpage with the modified media file and metadata received from the recipient device 820. In this way, the intermediary server 840 may provide a media file and or metadata that represent the changes made by all of the users in the group that have access to the media file information stored on the intermediary server 840. The intermediary server 840 may also be configured to record backup files so that the media file and associated metadata can be reverted back to an earlier version if desired by the source user or some other user.

The functions described above with respect to the various embodiments of the present invention may be carried out in many ways. For example, any suitable means for carrying out each of the functions described above may be employed to carry out embodiments of the invention. According to one aspect of the present invention, all or a portion of the system of the present invention generally operates under control of a computer program product. The computer program product for performing the various processes and operations of embodiments of the present invention includes a computer-readable storage medium, such as a non-volatile storage medium, and computer-readable program code portions, such as a series of computer instructions, embodied in the computer-readable storage medium. For example, in one embodiment, the respective processors of the source and recipient devices generally execute a reflective media application in order to perform the various functions described above with reference to the source and recipient devices, such as those shown in conjunction with FIGS. 4-6.

In this regard, FIGS. 4-6 are schematic illustrations, flowcharts, or block diagrams of methods, systems, devices, and computer program products according to embodiments of the present invention. It will be understood that each block of a flowchart or each step of a described method can be implemented by computer program instructions. These computer program instructions may be loaded onto a computer or other programmable apparatus to produce a machine, such that the instructions which execute on the computer or other programmable apparatus create means for implementing the functions specified in the described block(s) or step(s). These computer program instructions may also be stored in a computer-readable memory that can direct a computer or other programmable apparatus to function in a particular manner, such that the instructions stored in the computer-readable memory produce an article of manufacture including instruction means which implement the function specified in the described block(s) or step(s). The computer program instructions may also be loaded onto a computer or other programmable apparatus to cause a series of operational steps to be performed on the computer or other programmable apparatus to produce a computer implemented process such that the instructions which execute on the computer or other programmable apparatus provide steps for implementing the functions specified in the described block(s) or step(s).

It will also be understood that each block or step of a described herein, and combinations of blocks or steps, can be implemented by special purpose hardware-based computer systems which perform the specified functions or steps, or combinations of special purpose hardware and computer instructions.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Although specific terms are employed herein, they are used in a generic and descriptive sense only and not for purposes of limitation.

That which is claimed:

1. A method of supplementing data stored in a source device operated by a first party, the method comprising:
communicating the data to at least one recipient device operated by a second party;
receiving use information from the at least one recipient device, the use information relating to an action taken with respect to the data following communication to the at least one recipient device; and
supplementing the data stored in the source device based on the use information from the at least one recipient device.

2. The method of claim 1, further comprising:
determining how the data stored in the source device is to be supplemented when use information is received from two or more recipient devices.

3. The method of claim 1, wherein the use information comprises a label that was assigned to the data in the at least one recipient device, and wherein the supplementing the data comprises assigning the label to the data stored in the source device.

4. The method of claim 1, wherein the use information comprises organizational information based on how the data was organized in the at least one recipient device, and wherein the supplementing the data comprises organizing the data stored in the source device based on the organizational information.

5. The method of claim 1, further comprising:
communicating source use information parameters that at least partially define the use information to be provided by the recipient device.

6. The method of claim 1, further comprising:
communicating source use information parameters that at least partially define how the use information should be provided by the recipient device.

7. A computer program product for supplementing data stored in a source device operated by a first party, the computer program product comprising at least one computer-readable storage medium having computer-readable program code portions stored therein, the computer-readable program code portions comprising:
a first executable portion for communicating the data to at least one recipient device operated by a second party;
a second executable portion for receiving use information from the at least one recipient device, the use information relating to an action taken with respect to the data following communication to the at least one recipient device; and
a third executable portion for supplementing the data stored in the source device based on the use information from the at least one recipient device.

8. The computer program product of claim 7, further comprising:
a fourth executable portion for determining how the data stored in the source device is to be supplemented when use information is received from two or more recipient devices.

9. The computer program product of claim 7, wherein the use information comprises a label that was assigned to the data in the at least one recipient device, and wherein the third executable portion comprises an executable portion for assigning the label to the data stored in the source device.

10. The computer program product of claim 7, wherein the use information comprises organizational information based on how the data was organized in the at least one recipient device, and wherein the third executable portion comprises an executable portion for organizing the data stored in the source device based on the organizational information.

11. The computer program product of claim 7, further comprising:
a fourth executable portion for providing source use information parameters to the recipient device, the source use information parameters providing instructions to the at least one recipient device for the communication of use information back to the source device.

12. A source device operated by a first party, the source device comprising:
a memory device for storing data; and
a processor operatively coupled to the memory device and configured to:
communicate the data to at least one recipient device operated by a second party;
receive use information from the at least one recipient device, the use information relating to an action taken with respect to the data following communication to the at least one recipient device; and
supplement the data stored in the source device based on the use information from the at least one recipient device.

13. The source device of claim 12, wherein the processor is further configured to determine how the data stored in the source device is to be supplemented when use information is received from two or more recipient devices.

14. The source device of claim 12, wherein the use information comprises a label that was assigned to the data in the at least one recipient device, and wherein the processor is further configured to assign the label to the data stored in the source device.

15. The source device of claim 12, wherein the use information comprises organizational information based on how the data was organized in the at least one recipient device, and wherein the processor is further configured to organize the data stored in the source device based on the organizational information.

16. The source device of claim 12, wherein the processor is further configured to provide source use information parameters to the recipient device, the source use information parameters providing instructions to the at least one recipient device for the communication of use information back to the source device.

17. A source device operated by a first party, the source device comprising:
means for storing data;
means for communicating the data to at least one recipient device operated by a second party;
means for receiving use information from the at least one recipient device, the use information relating to an action taken with respect to the data following communication to the at least one recipient device; and
means for supplementing the data stored in the source device based on the use information from the at least one recipient device.

18. The source device of claim 17, further comprising:
means for providing source use information parameters to the at least one recipient device, the source use information parameters at least partially defining the use information to be provided by the recipient device.

19. The source device of claim 17, further comprising:
means for providing instructions to the at least one recipient device as to how use information should be communicated back to the source device.

20. A method comprising:
receiving data at a recipient device, the data being received from a source device;
taking action with respect to the data following receipt at the recipient device; and
communicating use information to the source device, the use information relating to an action taken with respect to the data.

21. The method of claim 20, further comprising:
receiving source use information parameters with the data and communicating use information based on the source use information parameters.

22. The method of claim 20, further comprising:
communicating use information based on recipient use information parameters, the recipient use information parameters being stored in the recipient device.

23. The method of claim 20, wherein the recipient device comprises recipient use information parameters stored therein, the recipient use information parameters comprising instructions for communicating use information, and wherein the method further comprises:
receiving source use information parameters from the source device, the source use information parameters providing instructions for communicating use information; and
prioritizing between the recipient use information parameters and the source use information parameters.

24. The method of claim 20, further comprising:
transmitting the data to at least one other device;
receiving other device use information from the at least one other device, the other device use information relating to an action taken by at least one other device with respect to the data after the transmission of the data to the at least one other device; and
communicating the other device use information to the source device.

25. The method of claim 20, wherein the use information comprises contextual information relating to the context in which the action was taken.

26. A computer program product, the computer program product comprising at least one computer-readable storage medium having computer-readable program code portions stored therein, the computer-readable program code portions comprising:
a first executable potion for receiving data at a recipient device, the data being received from a source device;
a second executable portion for taking action with respect to the data following receipt at the recipient device; and
a third executable portion for communicating use information to the source device, the use information relating to an action taken with respect to the data.

27. The computer program product of claim 26, further comprising:
a fourth executable portion for receiving source use information parameters from the source device, wherein the third executable portion comprises an executable portion for communicating use information based on the source use information parameters.

28. The computer program product of claim 26, further comprising:
a fourth executable portion for providing recipient use information parameters, wherein the third executable portion comprises an executable portion for communicating use information based on the recipient use information parameters.

29. The computer program product of claim 26, wherein the recipient device comprises recipient use information parameters stored therein, the recipient use information parameters comprising instructions for communicating use information, and wherein the computer program product further comprises:
a fourth executable portion for receiving source use information parameters from the source device, the source use information parameters providing instructions for communicating use information; and
a fifth executable portion for prioritizing between the recipient use information parameters and the source use information parameters.

30. The computer program product of claim 26, further comprising:
a fourth executable portion for transmitting the data to at least one other device; and
a fifth executable portion for receiving other device use information from the at least one other device, the other device use information relating to an action taken by at least one other device with respect to the data after the transmission of the data to the at least one other device;
wherein the third executable portion comprises an executable portion for communicating the other device use information to the source device.

31. A recipient device comprising:
a communication interface; and
a processor operatively coupled to the communication interface, the processor configured to:
receive data via the communication interface, the data being received from a source device;
take action with respect to the data; and
communicate use information to the source device via the communication interface, the use information relating to an action taken with respect to the data.

32. The recipient device of claim 31, wherein the processor is further configured to receive source use information parameters via the communication interface and communicate use information based on the source use information parameters.

33. The recipient device of claim 31, further comprising:
a memory operatively coupled to the processor and comprising recipient use information parameters stored therein;
wherein the processor is configured to communicate use information based on recipient use information parameters.

34. The recipient device of claim 31, further comprising:
a memory operatively coupled to the processor and comprising recipient use information parameters stored therein, the recipient use information parameters providing instructions for communicating use information;
wherein the processor is further configured to receive source use information parameters via the communication interface, the source use information parameters providing instructions for communicating use information; and
wherein the processor is further configured to prioritize between the recipient use information parameters and the source use information parameters.

35. The recipient device of claim 31, wherein the processor is further configured to:
transmit the data to at least one other device via the communication interface;
receive other device use information from the at least one other device via the communication interface, the other device use information relating to an action taken by at least one other device with respect to the data after the transmission of the data to the at least one other device; and
communicate the other device use information to the source device via the communication interface.

36. A recipient device comprising:
means for receiving data from a source device;
means for taking action with respect to the data; and
means for communicating use information to the source device, the use information relating to an action taken with respect to the data.

37. The recipient device of claim 36, further comprising:
means for receiving source use information parameters from the source device; and
means for communicate use information based on the source use information parameters.

38. The recipient device of claim 36, further comprising:
means for storing recipient use information parameters; and
means for communicating use information based on recipient use information parameters.

39. The recipient device of claim 36, further comprising:
means for storing recipient use information parameters, the recipient use information parameters providing instructions for communicating use information;
means for receiving source use information parameters, the source use information parameters providing instructions for communicating use information; and
means for prioritizing between the recipient use information parameters and the source use information parameters.

40. The recipient device of claim 36, further comprising:
means for transmitting the data to at least one other device;
means for receiving other device use information from the at least one other device, the other device use information relating to an action taken by at least one other device with respect to the data after the transmission of the data to the at least one other device; and
means for communicating the other device use information to the source device.

41. A reflective media system comprising:
a recipient device configured to receive a media file and metadata associated with the media file and store the media file in a memory of the recipient device, wherein the metadata comprises source information related to the source of the media file, and wherein the recipient device is configured to communicate use information to another device based on the source information, the use information comprising information about how the recipient device has used the media file stored in the memory of the recipient device.

42. The reflective media system of claim 41, wherein the recipient device is configured to communicate the use information automatically if the source information contains information about a source that is included on a list of approved sources stored in the memory of the recipient device.

43. The reflective media system of claim 41, wherein the source information comprises an address of a source device and wherein the recipient device is configured to communicate use information to the address of the source device.

44. The reflective media system of claim 41, wherein the source information comprises an address of an intermediary server connected to the Internet and wherein the recipient device is configured to communicate use information to the intermediary server via the Internet.

45. The reflective media system of claim 44, wherein the intermediary server is configured to process the use information and provide information related to the use information to a source device, the source device having provided the media file to the recipient device.

46. The reflective media system of claim 45, wherein the source device had provided the media file to the recipient device via the intermediary server.

47. The reflective media system of claim 41, wherein the use information comprises metadata that the recipient device added to the media file.

48. The reflective media system of claim 41, wherein the use information comprises edits that the recipient device made to the media file.

49. The reflective media system of claim 41, wherein the use information comprises information about whether the recipient device printed, forwarded, modified, or viewed the media file stored in the memory of the recipient device.

50. The reflective media system of claim 41, wherein the use information comprises information about at least one other media file stored in the memory of the recipient device that the recipient device associated with the media file.
